(19) United States
(12) Patent Application Publication
(10) Pub. No.: US 2025/0147403 A1
(43) Pub. Date: May 8, 2025

(54) LENS APPARATUS AND IMAGE PICKUP APPARATUS HAVING THE SAME

(71) Applicant: CANON KABUSHIKI KAISHA, Tokyo (JP)

(72) Inventors: TOMONORI ISHIKAWA, Tochigi (JP); GAKU TAKAHASHI, Tochigi (JP); KATSUHIKO SATO, Tochigi (JP)

(21) Appl. No.: 18/918,212

(22) Filed: Oct. 17, 2024

(30) Foreign Application Priority Data
Nov. 8, 2023 (JP) 2023-190512

(51) Int. Cl. G03B 35/24

(52) U.S. Cl. CPC G03B 35/24

(57) ABSTRACT

A lens apparatus includes a base member having a first opening corresponding to a first optical system and a second opening corresponding to a second optical system, and a holding member that holds the base member. The base member includes a first positioning portion formed at a position distant from a center of the first opening and a center of the second opening, and a second positioning portion formed at a position opposite to the first positioning portion with respect to a midpoint between the center of the first opening and the center of the second opening, and configured to restrict the base member from rotating about an optical axis relative to the holding member. A predetermined inequality is satisfied.

### BACKGROUND

### Technical Field

The present disclosure relates to a lens apparatus and an image pickup apparatus having the same.

### Description of Related Art

It is important for a stereoscopic image pickup apparatus to equalize shift amounts of optical axes for the left and right optical systems arranged in parallel, relative to an image sensor from designed nominal positions, because unequal shift amounts directly deteriorate the optical performance and stereoscopic images. A surface contact structure (see Japanese Patent No. 4378434) and a structure that provides a rotation center of a positioning unit at the center of the positioning unit (see Japanese Patent No. 6561840) are known positioning configurations for a plurality of optical systems

However, in the configuration of Japanese Patent No. 4378434, the shift amounts of the left and the right become uneven by the orthogonality of the two planes that serve as the contact surfaces. In addition, the configuration of Japanese Patent No. 6561840 can equalize the shift amounts of the left and the right, but may not place the positioning unit at the unit center due to space limitations.

### SUMMARY

A lens apparatus according to one aspect of the disclosure includes a base member having a first opening corresponding to a first optical system and a second opening corresponding to a second optical system, and a holding member that holds the base member. The base member includes a first positioning portion formed at a position distant from a center of the first opening and a center of the second opening, and a second positioning portion formed at a position opposite to the first positioning portion with respect to a midpoint between the center of the first opening and the center of the second opening, and configured to restrict the base member from rotating about an optical axis relative to the holding member. In a case where the lens apparatus is viewed from an optical axis direction, B is a distance [mm] between the center of the first opening and the center of the second opening, (S, T) is coordinates of the center of the first positioning portion in a case where the center of the base member is an origin, r1 is a distance [mm] from the center of the first positioning portion to the center of the first opening and is expressed by the following equation, r2 is a distance [mm] from the center of the first positioning portion to the center of the second opening and is expressed by the following equation,

$$r 1 = \sqrt{{( B / 2 - S )}^{2} + {T}^{2}} \qquad ( 1 )$$

$$r 2 = \sqrt{{( B / 2 - S )}^{2} + {T}^{2}} \qquad ( 2 )$$

the following inequality is satisfied:

$$\vert r 2 - r 1 \vert \times tan θ < 0.05$$

where θ is an angle tolerance [°] of the base member relative to the holding member.

Alternatively, the base member may include a second positioning portion configured to restrict the base member from rotating relative to the holding member about an optical axis, and the holding member may include a third positioning portion that contacts an outer circumferential surface of the base member at least three locations and determines a center of the base member.

Further features of various embodiments of the disclosure will become apparent from the following description of embodiments with reference to the attached drawings.

### BRIEF DESCRIPTION OF THE DRAWINGS

FIG. 1 is a schematic diagram of an image pickup apparatus according to one embodiment of the present disclosure.

FIG. 2 is a schematic diagram of a light amount control apparatus.

FIG. 3 is a schematic diagram of the light amount control apparatus.

FIG. 4 is an exploded view of the light amount control apparatus.

FIG. 5 illustrates an example of a positioning configuration.

FIG. 6 explains a problem in a case where the present disclosure is not applied.

FIG. 7 explains an application range of the positioning configuration of the present disclosure.

FIG. 8 illustrates another example of a positioning configuration.

FIG. 9 illustrates an optical system to which the present disclosure is applied.

### DETAILED DESCRIPTION

Referring now to the accompanying drawings, a detailed description will be given of embodiments according to the disclosure. Corresponding elements in respective figures will be designated by the same reference numerals, and a duplicate description thereof will be omitted.

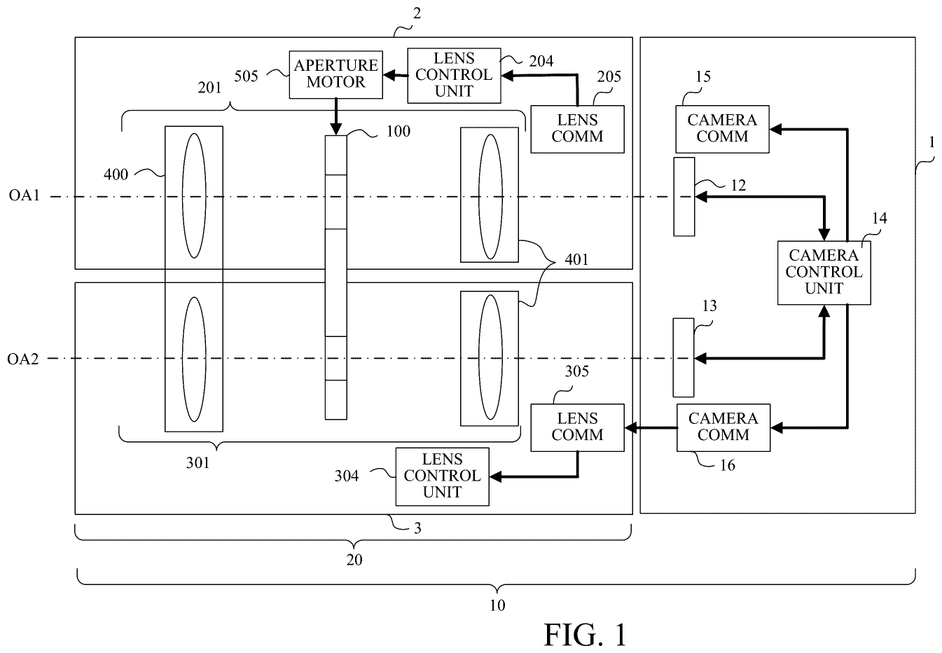

FIG. 1 is a schematic diagram of an image pickup apparatus 10 according to one embodiment of the present disclosure. The image pickup apparatus 10 includes a camera body 1, and a stereoscopic optical unit (lens apparatus) 20 integrated with the camera body 1.

The stereoscopic optical unit 20 includes a first optical unit 2, and a second optical unit 3. In this embodiment, the stereoscopic optical unit 20 is fixed integrally to the camera body 1, but may be attached to and detachable from the camera body 1. The first optical unit 2 includes a first optical system 201, a lens control unit 204, and a lens communication unit 205. The second optical unit 3 includes a second optical system 301, a lens control unit 304, and a lens communication unit 305. The first optical system 201 and the second optical system 301 have the same optical configuration, and are arranged in parallel on the left and right so that their optical axes OA1 and OA2 are parallel to each other. In the following description, the direction in which the optical axes OA1 and OA2 extend will be referred to as an optical axis direction. The first optical system 201 and the second optical system 301 are moved along the optical axis direction for zooming and focusing by a zoom motor and a focus motor as unillustrated driving sources. The first optical system 201 and the second optical system 301 may include one or more lenses, or may include optical elements other than lenses such as a prism or a mirror. The first optical system 201 and the second optical system 301 may also include shift lenses that move in directions perpendicular to the optical axes OA1 and OA2 (directions perpendicular to the optical axes) according to the shake of the image pickup apparatus 10 due to handheld shake or the like to reduce (correct) image blur.

The stereoscopic optical unit 20 includes a single light amount control apparatus 100 provided in common for the first optical system 201 and the second optical system 301. The light amount control apparatus 100 includes a first aperture stop provided for the first optical system 201, a second aperture stop provided for the second optical system 301, and an aperture motor 505 as a single driving source provided in common for the first aperture stop and the second aperture stop. The first and second aperture stops are moved by the aperture motor 505, so that the aperture diameters formed by the first and second aperture stops change, and light amounts are controlled (adjusted).

The stereoscopic optical unit 20 further includes a lens holder 400 that holds the lenses of the first optical system 201 and the second optical system 301 together, and a lens holder 401 that holds the lenses of the first optical system 201 and the second optical system 301 separately. This embodiment can reduce (suppress) a shift amount between the center of each optical system and the corresponding optical axis in a case where a unit that holds the first optical system 201 and the second optical system 301 together is assembled into a holding member (e.g., a lens barrel) provided in the stereoscopic optical unit 20. Therefore, this embodiment is applicable to the lens holder 400 that holds the first optical system 201 and the second optical system 301 together, and is also applicable to the light amount control apparatus 100.

The lens control units 204 and 304 control the zoom motor and focus motor according to a zoom command and a focus command from the camera body 1 via the lens communication units 205 and 305, respectively. The lens control unit 204 also controls the aperture motor 505 based on an aperture command from the camera body 1 via the lens communication unit 205.

The camera body 1 includes a first image sensor 12, a second image sensor 13, a camera control unit 14, and camera communication units 15 and 16. The first image sensor 12 photoelectrically converts (captures) an object image formed by the first optical system 201. The second image sensor 13 photoelectrically converts an object image formed by the second optical system 301. The first image sensor 12 and the second image sensor 13 are photoelectric conversion elements such as CMOS sensors or CCD sensors.

The camera control unit 14 transmits various commands (instructions) to the lens control units 204 and 304 via the camera communication units 15 and 16 and the lens communication units 205 and 305. The camera control unit 14 includes an unillustrated image processing unit that performs various processing for the image signals from the first image sensor 12 and the second image sensor 13 to generate first image data and second image data. The first image data and the second image data are displayed as right-eye and left-eye images on an observation apparatus such as a monitor or a head mount display, respectively, so that the observer can observe a stereoscopic image. In this embodiment, the camera body 1 includes two image sensors for the two optical systems, but may be configured to obtain image signals for generating the first and second image data in two areas on a single image sensor provided for the two optical systems.

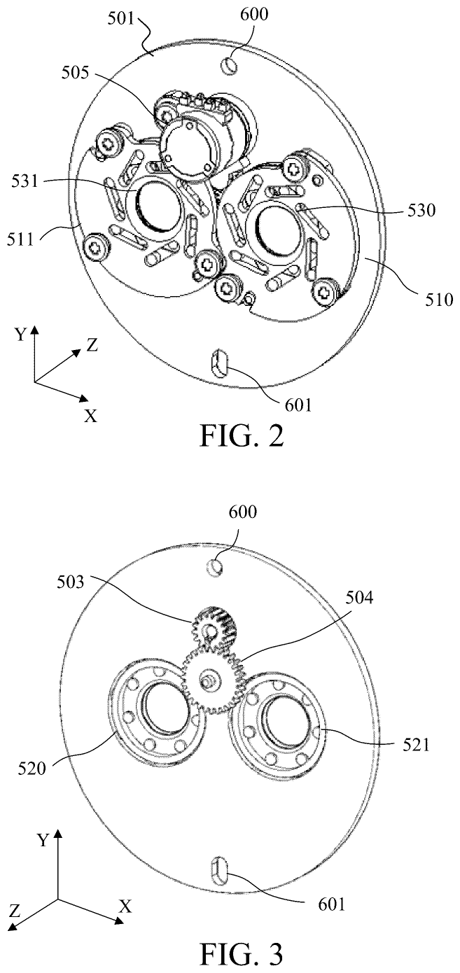

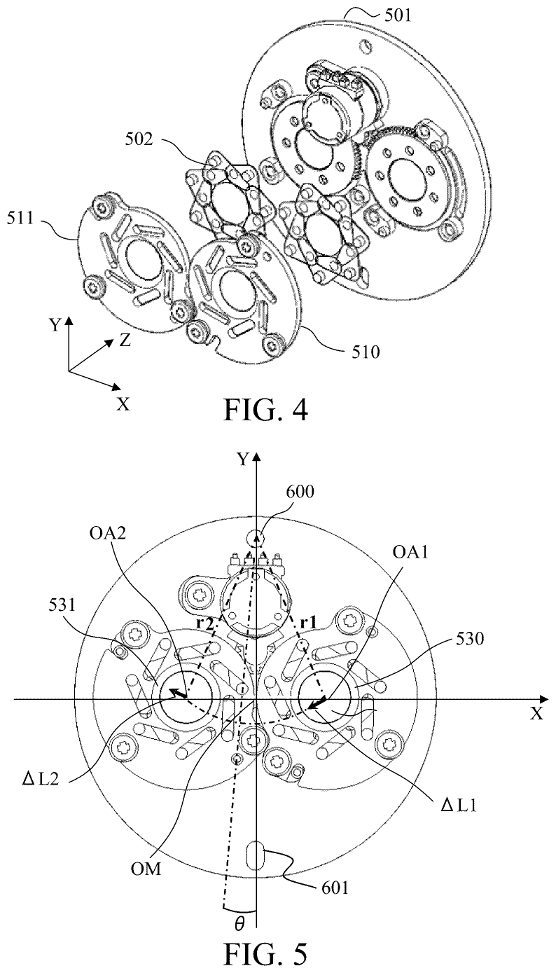

FIGS. 2 and 3 are schematic diagrams of the light amount control apparatus 100. FIG. 4 is an exploded view of the light amount control apparatus 100. The light amount control apparatus 100 includes a first aperture stop including a plurality of blade members 502 for the first optical system 201, a second aperture stop including a plurality of blade members 502 for the second optical system 301, and an opening/closing mechanism that opens and closes the blade members 502. In this embodiment, seven blade members 502 are provided for each aperture stop. The opening/closing mechanism includes an aperture motor (driving source) 505, an aperture base plate (base member) 501, a stepped gear (relay gear) 504, a first drive ring (first rotating member) 520, a second drive ring (second rotating member), and a second cam plate (pressing member).

The aperture motor 505 is a stepping motor, and a pinion gear 503 (driving gear) is fixed to the rotational drive shaft so as to be rotatable together with the aperture motor 505. The aperture motor 505 is fixed to the aperture base plate 501 with a screw. The pinion gear 503 protrudes from a hole formed in the aperture base plate 501 toward the stepped gear 504.

The aperture base plate 501 is formed with a first opening corresponding to the first optical system 201 and a second opening corresponding to the second optical system 301. The aperture base plate 501 is held by an unillustrated holding member (e.g., a lens barrel) provided in the stereoscopic optical unit 20. The aperture base plate 501 contacts the holding member in the optical axis direction, and the position and angle in the direction perpendicular to the optical axis are determined.

A plurality of engagement (fitting) receivers are formed along the circumferential direction on the inner circumference of the first opening. Engagement (fitting) portions provided on the outer circumference of the first drive ring 520 are engaged with (fit into) the plurality of engagement receivers. The first drive ring 520 is held rotatably around the central axis of the first opening (i.e., around the optical axis OA1 of the first optical system 201) relative to the aperture base plate 501. Thereby, a first aperture stop 530 corresponding to the first optical system 201 is formed.

A plurality of engagement receivers are formed along the circumferential direction on the inner circumference of the second opening. Engagement portions provided on the outer circumference of the second drive ring 521 are engaged with the plurality of engagement receivers. The second drive ring 521 is held rotatably around the central axis of the second opening (i.e., around the optical axis OA2 of the second optical system 301) relative to the aperture base plate 501. Thereby, a second aperture stop 531 corresponding to the second optical system 301 is formed.

In a case where the aperture motor 505 is driven and the pinion gear 503 rotates, the first drive ring 520 and the second drive ring 521 rotate in the same direction relative to the aperture base plate 501 via the stepped gear 504.

The first cam plate 510 is disposed so as to sandwich the first drive ring 520 and the blade members 502 between the first cam plate 510 and the aperture base plate 501, and is fixed to the aperture base plate 501 with screws. The second cam plate 511 is disposed so as to sandwich the second drive ring 521 and the multiple blade members 502 between the second cam plate 511 and the aperture base plate 501, and is fixed to the aperture base plate 501 with screws. Each of the cam pins of the blade members 502 is engaged with a corresponding cam groove in the cam plate. Due to this configuration, as the first drive ring 520 and the second drive ring 521 rotate, the blade members 502 move in the circumferential direction together with the drive rings. In addition, the cam pins of the blade members 502 move along the cam grooves in the cam plate with which the cam pins are engaged, and cause the blade members 502 to rotate (pivot) in the opening or closing direction. Thereby, the aperture diameter (aperture value or F-number) formed in each of the first aperture stop 530 and the second aperture stop 531 can be changed.

A description will now be given of the positioning configuration according to this embodiment. FIG. 5 illustrates an example of the positioning configuration. The line passing through the optical axes OA1 and OA2 is defined as an X-axis (horizontal direction on the paper), a bisector of the line connecting the optical axes OA1 and OA2 is defined as a Y-axis (vertical direction on the paper), and an origin is defined as OM. The above coordinate axes will be used in the following description.

The aperture base plate 501 is formed with a positioning hole (first positioning portion) 600 and a long (or elongated) hole (second positioning portion) 601 that restricts the aperture base plate 501 from rotating around the optical axis. The positioning hole 600 is formed at a position distant from the center of the first opening and the center of the second opening. In this embodiment, where r1 is a distance [mm] from the positioning hole 600 to the center of the first opening, and r2 is a distance [mm] from the positioning hole 600 to the center of the second opening, the positioning hole 600 is disposed so that the distances r1 and r2 are equal. Here, “equal” includes not only “strictly equal” but also “substantially equal (approximately equal).” The long hole 601 is disposed at a position that is approximately symmetrical to the positioning hole 600 with respect to the X-axis, that is, at a position opposite to the positioning hole 600 with respect to the midpoint of the first and second openings. In FIG. 5, as an example, the positioning hole 600 is disposed at the 12 o'clock position, and the long hole 601 is disposed at the 6 o'clock position. In a case where the light amount control apparatus 100 is assembled to the holding member of the stereoscopic optical unit 20, an angle tolerance (attachment angle tolerance) θ[°] may occur. In this case, a difference ΔL1 between the aperture center of the first aperture stop 530 and the optical axis OA1 and a difference ΔL2 between the aperture center of the second aperture stop 531 and the optical axis OA2 occur. However, the differences ΔL1 and ΔL2 are equal, and the performance difference between the left and right optical systems can be suppressed (reduced).

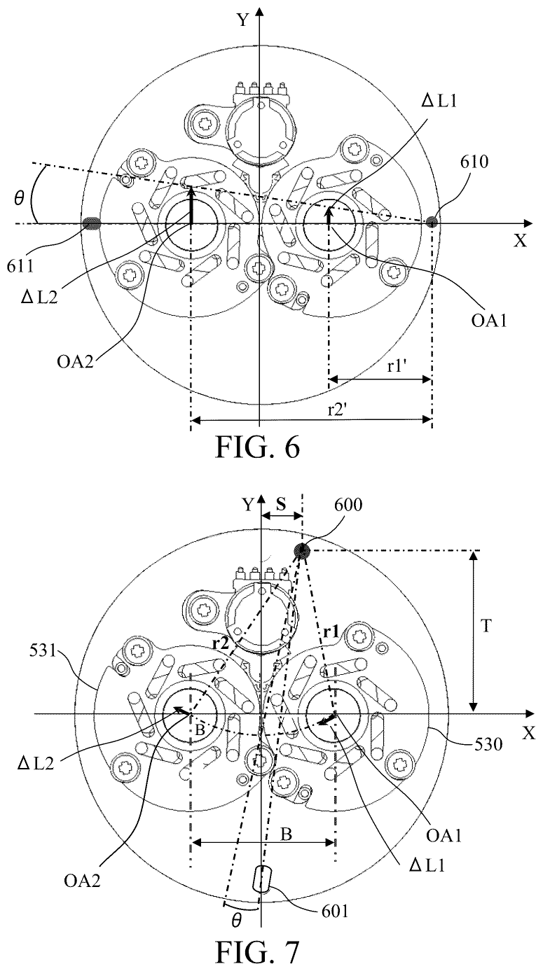

A description will now be given of a problem that arises in a case where the present disclosure is not applied. FIG. 6 explains the problem that arises in a case where the present disclosure is not applied. In FIG. 6, the positioning hole 610 is disposed at the 3 o'clock position, and the long hole 611 is disposed at the 9 o'clock position. At this time, a distance r1′ from the positioning hole 610 to the aperture center of the first aperture stop 530 is different from a distance r2′ from the positioning hole 610 to the aperture center of the second aperture stop 531, and a difference ΔL2 is longer than a difference ΔL1. Therefore, a problem occurs in that the optical performance and the stereoscopic image deteriorate.

This embodiment has discussed the configuration and effect of disposing the positioning hole 600 at a position so that the distance r1 from the optical axis OA1 and the distance r2 from the optical axis OA2 are approximately equal. A description will now be given of the definition of “approximately equal” at which the effect of this embodiment is obtained. FIG. 7 explains an application range of the positioning configuration according to this embodiment, illustrating a state in which the positioning hole 600 is disposed at a position distant from the center of the light amount control apparatus 100 (aperture base plate 501) by a distance S in the X-axis direction and a distance T in the Y-axis direction. At this time, the distance r1 from the positioning hole 600 to the optical axis OA1 and the distance r2 from the positioning hole 600 to the optical axis OA2 can be calculated using the following equations (1) and (2), respectively:

$$r 1 = \sqrt{{( B / 2 - S )}^{2} + {T}^{2}} \qquad ( 1 )$$

$$r 2 = \sqrt{{( B / 2 - S )}^{2} + {T}^{2}} \qquad ( 2 )$$

where B is a distance [mm] between the center of the first opening and the center of the second opening.

As described above, an angle tolerance θ occurs in a case where the light amount control apparatus 100 is assembled into the stereoscopic optical unit 20, so the difference ΔL1 from the optical axis OA1 and the difference ΔL2 from the optical axis OA2 can be calculated using the following equations (3) and (4), respectively:

$$Δ L 1 = r 1 \times tan θ \qquad ( 3 )$$

$$Δ L 2 = r 2 \times tan θ \qquad ( 4 )$$

A permissible value of the relative difference between the differences ΔL1 and ΔL2 is, for example, 0.05 mm, as expressed in the following inequality (5):

$$\vert Δ L 2 - Δ L 1 \vert < 0. 05 \qquad ( 5 )$$

At this time, a range of position coordinates (S, T) of the positioning hole 600 that satisfies equations (1) to (4) and inequality (5) can be determined. Thus, the effect of this embodiment can be obtained even in a range in which the position of the positioning hole 600 can provide approximately equal distances.

Inequality (5) may be replaced with inequality (5a) below:

$$\vert Δ L 2 - Δ L 1 \vert < 0.04 \qquad ( 5 a )$$

Inequality (5) may be replaced with inequality (5b) below:

$$\vert Δ L 2 - Δ L 1 \vert < 0.03 \qquad ( 5 b )$$

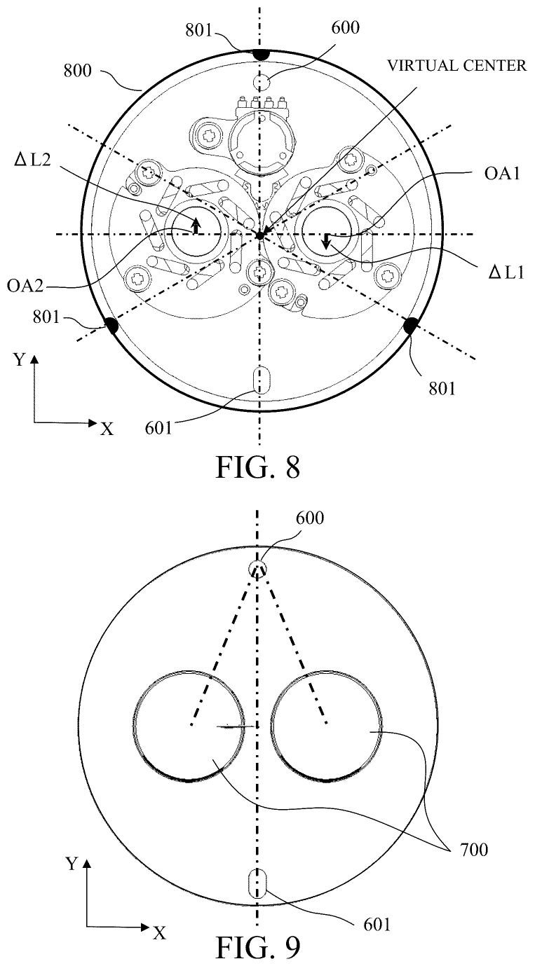

The positioning configuration is not limited to the example in FIG. 5. FIG. 8 illustrates another example of the positioning configuration. A lens barrel 800 has receivers (third positioning portions) 801 that contact at least three locations on the outer diameter (outer circumferential surface) of the light amount control apparatus 100 (aperture base plate 501). The receivers 801 provide the light amount control apparatus 100 (aperture base plate 501) with a virtual rotational center (virtual center). Due to this configuration, even if a rotation center cannot be provided in the central portion of the light amount control apparatus 100 due to space limitations, the rotation center can be located in the center of the light amount control apparatus 100. Thereby, if an attachment angle tolerance of the light amount control apparatus 100 occurs in the clockwise direction, for example, a difference ΔL1 occurs in the +Y axis direction and a difference ΔL2 occurs in the −Y axis direction, but the shift amounts are equal. Therefore, the performance difference between the left and right optical systems can be suppressed (reduced).

While this embodiment uses a light amount control apparatus, the present disclosure may also be applied to an optical system in which lenses 700 are held as illustrated in FIG. 9.

While the disclosure has described example embodiments, it is to be understood that some embodiments are not limited to the disclosed embodiments. The scope of the following claims is to be accorded the broadest interpretation so as to encompass all such modifications and equivalent structures and functions.

This embodiment can provide a lens apparatus that can suppress a performance difference between left and right optical systems.

This application claims priority to Japanese Patent Application No. 2023-190512, which was filed on Nov. 8, 2023, and which is hereby incorporated by reference herein in its entirety.

What is claimed is:

1. A lens apparatus comprising:
a base member having a first opening corresponding to a first optical system and a second opening corresponding to a second optical system; and
a holding member that holds the base member,
wherein the base member includes:
a first positioning portion formed at a position distant from a center of the first opening and a center of the second opening, and
a second positioning portion formed at a position opposite to the first positioning portion with respect to a midpoint between the center of the first opening and the center of the second opening, and configured to restrict the base member from rotating about an optical axis relative to the holding member, and
wherein in a case where the lens apparatus is viewed from an optical axis direction, B is a distance [mm] between the center of the first opening and the center of the second opening, (S, T) is coordinates of the center of the first positioning portion in a case where the center of the base member is an origin, r1 is a distance [mm] from the center of the first positioning portion to the center of the first opening and is expressed by the following equation, r2 is a distance [mm] from the center of the first positioning portion to the center of the second opening and is expressed by the following equation,
$$r 1 = \sqrt{{( B / 2 - S )}^{2} + {T}^{2}} \qquad ( 1 )$$
$$r 2 = \sqrt{{( B / 2 - S )}^{2} + {T}^{2}} \qquad ( 2 )$$
the following inequality is satisfied:
$$\vert r 2 - r 1 \vert \times tan θ < 0.05$$
where θ is an angle tolerance [°] of the base member relative to the holding member.

2. A lens apparatus comprising:
a base member having a first opening corresponding to a first optical system and a second opening corresponding to a second optical system; and
a holding member that holds the base member,
wherein the base member includes a second positioning portion configured to restrict the base member from rotating relative to the holding member about an optical axis, and
wherein the holding member includes a third positioning portion that contacts an outer circumferential surface of the base member at at least three locations and determines a center of the base member.

3. The lens apparatus according to claim 1, wherein the base member contacts the holding member in an optical axis direction, and thereby a position and angle in a direction perpendicular to the optical axis are determined.

4. The lens apparatus according to claim 1, wherein the first positioning portion is formed at a position distant from the center of the first opening and the center of the second opening by an equal distance.

5. An image pickup apparatus comprising:
the lens apparatus according to claim 1; and
an image sensor configured to photoelectrically convert an object image formed by the lens apparatus.

6. An image pickup apparatus comprising:
the lens apparatus according to claim 2; and
an image sensor configured to photoelectrically convert an object image formed by the lens apparatus.
